(19) United States
(12) Patent Application Publication
(10) Pub. No.: US 2026/0245145 A1
(43) Pub. Date: Aug. 20, 2026

(54) SYSTEM AND METHOD FOR CREATING, ISSUING, MONITORING, AND MANAGING STRUCTURED NOTES

(71) Applicant: Epic Notes, Inc., Boca Raton, FL (US)

(72) Inventor: Richard Ehrlich, Boca Raton, FL (US)

(21) Appl. No.: 19/058,880

(22) Filed: Feb. 20, 2025

(51) Int. Cl. G06Q 40/04

(52) U.S. Cl. CPC G06Q 40/04

(57) ABSTRACT

A networked system and method for the creation, issuance, and management of structured notes and investments therein, and in particular, the creation, issuance, and management of daily-issued structured notes. The system includes a network accessible user interface and collaboration tool that facilitates the creation, issuance, and management of structured notes. The system is configured to broadcast real-time alerts regarding the status of user-invested structured notes, including alerts based on real-time market data introduced into the system through third party integrations.

### SYSTEM AND METHOD FOR CREATING, ISSUING, MONITORING, AND MANAGING STRUCTURED NOTES

N/A

### BRIEF DESCRIPTION OF THE DRAWINGS

Those of skill in the art will recognize that the following description is merely illustrative of the principles of the disclosure, which may be applied in many ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

In the drawings:

FIG. 1 is a system environment, according to an embodiment.

FIG. 2 is a system environment, according to an embodiment.

FIG. 3 is an exemplary dashboard, according to an embodiment.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

### Overview

The present invention comprises various embodiments of a system and method that enables the creation, issuance, and management of structured notes and investments therein, and in particular, the creation, issuance, and management of daily-issued structured notes. In some embodiments, the system comprises a network accessible user interface and collaboration tool that facilitates the creation, issuance, and management of structured notes. Various methods and method steps related to the collaboration tool are also disclosed.

The system categorizes users into different classes, each with specific access privileges within the user interface, including Note Creator, Note Issuer, Investment Advisory Firm, Investment Advisors, and End User Investors. The system integrates with various data sources, including financial clearing houses and proprietary systems, to facilitate data exchange and streamline the structured note investment process. The Note Creator develops and proposes structured notes, which are then reviewed and priced by the Note Issuer. Upon approval, the notes are made available to Customers for investment. The system provides real-time reporting and monitoring functionalities, including automated notifications about note performance, portfolio management, and compliance activities. The system includes features for tracking customer activities, analyzing note performance, preparing compliance documents, and broadcasting interest summaries. A dashboard displays real-time metrics and market data, customizable by user class, and includes a secure messaging platform and educational resources.

### Structured Notes

Structured notes are hybrid financial instruments combining elements of debt securities and derivatives to provide customized risk-return profiles for investors. Structured notes can offer principal protection, yield enhancement, or market exposure, making them versatile tools for different investment strategies. An important characteristic, or desired characteristic, of structured notes is their ability to provide a level of protection against market volatility without the need to hedge through other investment vehicles. Structured notes also allow investors to invest in certain asset classes that are traditionally only available to large funds or the ultra-wealthy.

Structured notes typically consist of four main components:
The Underlying Asset or Index: The performance of the note is linked to an asset or index, such as the S&P 500, interest rates, commodities, or currencies.
Principal Protection: This guarantees the return of the initial investment, either fully or partially, at maturity.
Return Component: This includes features like participation rates, leverage factors, and caps on returns, which determine how much of the underlying asset's performance is passed on to the investor.
Maturity Date: The date when the investment returns are realized, which can range from one to ten years.

Traditionally, structured notes are made available through investment banks as “off the shelf” offerings of limited variation and limited accessibility. The present invention contemplates a system and method that enables the on-demand daily issuance of structured notes along with a set of management, collaboration, and monitoring tools enabled through a network-enabled user interface.

### System Structure

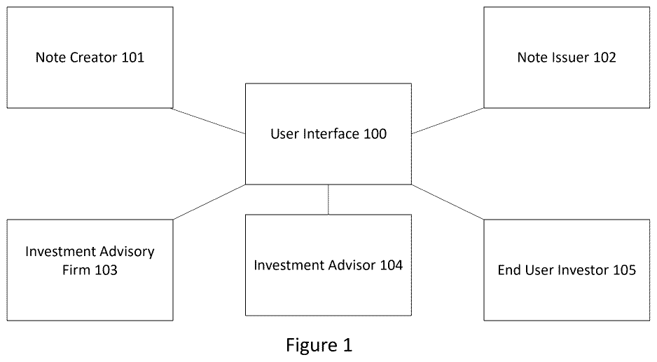

FIG. 1 show the relationship of various users and user classes of the system and method. Each class of user has a distinct set or sub-set of access privileges within the network-enabled user interface 100. For purposes of this disclosure, the term “user interface” shall refer to (1) the point of human-computer interaction and communication to a system or application and/or (2) the system or application itself. In some embodiments, the user classes include a Note Creator 101, a Note Issuer 102, an Investment Advisory Firm (also known as the “RIA”) 103, one or more Investment Advisors 104, and, optionally, on or more End User Investor 105 (collectively, “Users”). The three user classes along the bottom of FIG. 1, namely the Investment Advisory Firm 103, Investment Advisor(s) 104, and End User Investor(s) 105, are collectively referred to as the “Customers” or, individually, a “Customer”. In some embodiments, the “Investors” have a lower level of access to the user interface 100 as compared to the Note Creator 101 and the Note Issuer 102, as will be further described below. In some embodiments, the user interface 100 assigns and issues an encrypted storage sub-system to all or one of the Users which enables to the user interface to store and recall data and information assigned to a User, including high-security data says such personal information, account numbers, and investment history and activity.

### System Integrations

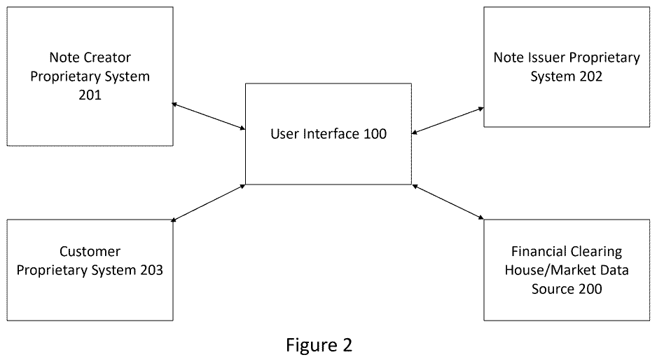

With reference to FIG. 2, in some embodiments, the user interface 100 is made accessible through a networked environment that is configured with one or more system integrations to enable the user interface 100 to communicate and exchange data with one or more data sources or systems associated with a User or one or more external data sources. In one example, the user interface 100 can receive inbound market data from a financial clearing house or third-party market data source 200. In another example, the user interface 100 can integrate with the “in-house” proprietary systems 201 or 202 (respectively) of the Note Creator 101 or Note Issuer 102. In another example, the user interface 100 can integrate with the “in house” proprietary systems 203 of the Customer, including such systems 203 which may directly or indirectly interface with one or more investment or bank accounts associated with the Customer. In some embodiments, the integrations include interoperability with one or more electronic funds transfer protocols including wire transfer, electronic checks, and automated clearing house (ACH), peer-to-peer (P2P) payments. System integrations may, in some embodiments, be accomplished through one or more application programming interfaces (API), messaging protocols, database sharing integrations, or hyperlinks to platforms associated with the User. Accordingly, these integrations enable the user interface 100 integrate with the various pre-existing systems held by the User classes or by third parties such that the user interface 100 can function as a centralized structured note investment issuance, collaboration, and management tool that obviates the need for Users to access multiple systems.

### Operational Workflow

In some embodiments, the Note Creator 101 has “administrative access” to the user interface 100 and has access rights to the user interface 100 to develop and create a proposed structured note. The details of the structured note include, without limitation, the four main components of the structured note described above. In some embodiments, the Note Creator 101 interacts with the user interface 101 to create a proposed structured note using an individualized or personalized investment strategy by analyzing and modulating the variables underlying at least the four main components of the structured note. In some embodiments, the Note Creator 101 can access and view market information obtained from one or more system integrations, including for example from a financial clearing house or third-party market data source, in order to obtain real-time information about stocks, bonds, indexes, and other investments which may form an underlying portion of the structured note.

Once the proposed structured note is created, the Note Creator 101 can then transmit, via the user interface 100, the data associated with the proposed structured note to the Note Issuer 102. The Note Creator 101 can use the user interface 100 to communicate with the Note Issuer 102 regarding the details of the structured note, including through a real-time messaging protocol. Alternatively, the Note Creator 101 can transmit data associated with the proposed structured note “offline” and/or outside of the user interface 100, for example by electronic mail. If and when the Note Issuer 102 accepts the proposed structured note, the Note Issuer 102 uses the user interface 100 to send proposed pricing data back to the Note Creator 101. If and when the Note Creator 101 approves of the pricing of the structured note, the Note Creator 101 can then, through the user interface 100, broadcast the availability of the structured note to the Customers. In some embodiments, the user interface 100 is configured to broadcast certain terms and conditions associated with a given structured note, which terms and conditions are made available at the time the availability of the investment is broadcast. This enables Customers to review and analyze the details of a given offering in real time, through the user interface 100, in order to make informed investment decisions.

At this point, the structured note is now available to be purchased by the Customers. Accordingly, one or more Customers can then, through the user interface 100, communicate an investment offer to the Note Creator 101 (or the Note Issuer 102, or both), by specifying at least the investment dollar amount and the account from which the investment will be made. Upon acceptance by the Note Creator 101 of the Customer investment offer, the Note Creator 101 can then place an order with the Note Issuer 101 either through the user interface 100 or “offline” similar to that described above with respect to the structured note proposal step. Order placement can be handled by the one or more of the aforementioned integrations including integration with the Customer's investment or bank account which can interface with a proprietary system of the either the Note Creator 101 or Note Issuer 102 to process payments. In some embodiments, the user interface 100 is configured to process orders that include recurring payment functionality, again leveraging system integrations to process structured note purchases over predetermined intervals for a predetermined amount of time. Upon completion of one or more orders for one or more structured notes, the user interface 100 is enabled to send order confirmations to the Note Issuer 102 either through the system integrations described above, or through external means such as electronic mail. Similarly, the user interface 100 is enabled to send order confirmations to the Customer(s) to confirm an order has been placed. At this point, the applicable Customer may be identified as the “Note Holder.” In some embodiments, the user interface 101 is also enabled to process selling or relinquishing of a Customer's position in a given structured note.

In some embodiments, the user interface 101 enables the Note Creator 101 to issue structured notes “same day”, meaning issuance of the note occurs on the same business day that the proposed structured note is accepted and approved by the Note Issuer. In some embodiments, a structured note offering may be broadcaster to Customers prior to a final term sheet being issued by the Note Issuer 102 to the Note Creator 101. For example, in some embodiments, the Note Creator 101 can preemptively broadcast a proposed structured note to Customers prior to submitting the proposed structure note to the Note Issuer 102. In doing so, the Note Creator 101 can, via the user interface 100, obtain contingent investment commitments from Customers and/or otherwise gain insight into Customer interest in a particular structured note to enable to the Note Creator 101 to fully inform the Note Issuer 102 during the structured note proposal process about the interest and/or potential trading volumes from committed Customers. Having this information in advance can facilitate more information decision-making by both the Note Creator 101 and the Note Issuer 102 and can facilitate, via the user interface 100, a real-time striking mechanism to lock in underlying asset prices within at least the same trading day. In some embodiments, the user interface 100 facilitations real-time monitoring and instantaneous selection of underlying asset prices at predetermined times, based on real-time data feeds from a financial clearing house or third-party market data source 200 and other sources via the system integrations described above. Accordingly, in some embodiments, the user interface 100 enables continuous, real-time monitoring of underlying asset pricing, providing the Note Creator 101 with flexibility to select the most favorable price entry points (and timing thereof) for a given proposed structured note. Monitoring and Reporting

In some embodiments, the user interface 100 is configured to provide a variety of real-time reporting, monitoring, and tracking functionality to enable Customers and other Users to track note performance, manage Customer portfolios, and engage in securities compliance activity. In some embodiments, the user interface 100 is configured to broadcast automated notifications regarding the status of one or more structured notes, or the status of a Customer's overall portfolio. In some embodiments, trigger event data for automated notification is obtained from third party integrations discussed above, for example from financial clearing house or third-party market data source. Notifications may include the following:

| Notification Type | User Class |
|---|---|
| Note Lifecycle | |
| Draft Created | All Users |
| Note Launched | Note Creator, Investment Advisory Firm, |
| | Investment Advisor, End User Investor |
| Note Closes in 1 hour | Investment Advisory Firm, Investment |
| | Advisor, End User Investor |
| Note Closed | Note Creator, Investment Advisory Firm, |
| | Investment Advisor, End User Investor |
| Note Events | |
| Note Breached | Note Creator and Note Holders; Investment |
| | Advisory Firm, Investment Advisor, End |
| | User Investor |
| Note Sold | Note Creator and Note Holders; Investment |
| | Advisory Firm, Investment Advisor, End |
| | User Investor |
| Call Alert | Note Creator and Note Holders; Investment |
| | Advisory Firm, Investment Advisor, End |
| | User Investor |
| Note Called | Note Creator and Note Holders; Investment |
| | Advisory Firm, Investment Advisor, End |
| | User Investor |
| Term Sheet Available | Note Creator and Note Holders; Investment |
| | Advisory Firm, Investment Advisor, End |
| | User Investor |
| Payment | |
| Note Observed | Note Creator and Note Holders; Investment |
| | Advisory Firm, Investment Advisor, End |
| | User Investor |
| Payment Pending | Note Creator and Note Holders; Investment |
| | Advisory Firm, Investment Advisor, End |
| | User Investor |
| Payment Missed | Note Creator and Note Holders; Investment |
| | Advisory Firm, Investment Advisor, End |
| | User Investor |
| Payment Paid | Note Creator and Note Holders; Investment |
| | Advisory Firm, Investment Advisor, End |
| | User Investor |
| Maturity | |
| Six Months To Maturity | Note Creator and Note Holders; Investment |
| | Advisory Firm, Investment Advisor, End |
| | User Investor |
| Three Months To Maturity | Note Creator and Note Holders; Investment |
| | Advisory Firm, Investment Advisor, End |
| | User Investor |
| One Month To Maturity | Note Creator and Note Holders; Investment |
| | Advisory Firm, Investment Advisor, End |
| | User Investor |
| One Week To Maturity | Note Creator and Note Holders; Investment |
| | Advisory Firm, Investment Advisor, End |
| | User Investor |
| RIA Events | |
| RIA Added | All Note Creator Users |
| Investment Advisor Added | Note Creator, Investment Advisory Firm |
| End User Investor Added | Note Creator, Investment Advisory Firm, |
| | Investment Advisor |
| RIA Profile Changed | Note Creator, Investment Advisory Firm |
| End User Investor Weekly | Note Creator, Investment Advisory Firm, |
| Summary Available | Investment Advisor, End User Investor |

### Dashboard and Customer Management

The user interface 100 is configured with a variety of customer management features and functionality to enable the Note Creator 101 to (1) track Customer activity, interactions, and interests; (2) identify the most popular and highest-performance structured note offerings; (3) analyze and track the performance of the structured notes; (4) prepare and complete compliance documents; and (5) compile and broadcast interest summaries to the Note Issuer 102 or Customers.

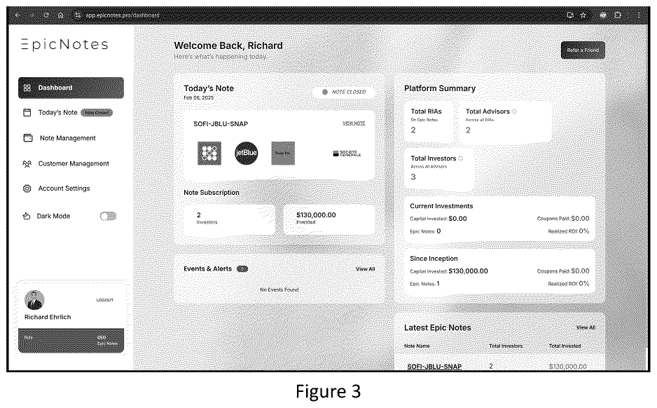

In some embodiments, the user interface 100 includes a graphical user interface (GUI) in the form of a dashboard, an example of which is shown in FIG. 3, which displays sub-sets of data and information depending on the class of User and authorizations assigned to the particular User. For example, at the Note Creator 101 level, the dashboard displays a variety of real-time metrics pertinent to the creation, issuing, and management of the entirety of the investment environment, including interactions with the Note Issuer 102. In one example, dashboard metrics specific to the Note Creator 101 include:

Metrics

Number of Notes Outstanding
Total Value of Notes
Average Note Size
Total monthly coupons of non-breached
Total annual
Total portfolio current yield
Theoretical Max Yield

For the Note Issuer 102, the dashboard displays real-time information regarding structured note status, including, for example, proposed, approved, issued, funded, outstanding liabilities, and the like. For the Customer, the dashboard displays real-time information specific to the performance and status of the Customer's investments, including historical data, projections, and the like.

The dashboard, through the previously discussed integrations, can also display real-time market data pulled from third party sources, such as a financial clearing house or third-party market data source. In some embodiments, the dashboard is configurable by the User to display a number of data fields and provides integrations for creating and customizing interactive graphs and charts.

In some embodiments, the user interface 100 includes a secure messaging platform to enable Users to interact and collaborate regarding investment activities. In some embodiments, messages can be sent User-to-User directly and, in other embodiments, messages can be broadcast systemwide or to individually-or-categorically selected Users.

In some embodiments, the user interface 100 includes a variety of education resources targeted at the various User classes, which resources including articles, videos, tutorials, a glossary of terms, a frequently-asked-questions database, and the like.

The system and method described herein may be implemented via recordable, executable, downloadable, or cloud-accessible software and/or combinations of such software and hardware. In some embodiments, the software for implementing the described system and method may be stored on a machine-readable storage medium and executed by one or more processors associated with the individual Users or associated with the user interface 100 through which all or a portion of the system is integrated and the method is carried out.

A “machine-readable storage medium,” as used herein, includes any device or medium capable of storing information in a form accessible by a machine, such as a computer, server, or network-enabled device. Such storage media may include, but are not limited to, read-only memory (ROM), random access memory (RAM), magnetic disk storage, optical storage, or flash memory devices. These storage media hold instructions that, when executed, cause the system to carry out the steps of creating, issuing, and managing structured notes, as well as enabling real-time collaboration between multiple parties involved in the structured note lifecycle.

The instructions may be stored in a computer-readable medium to direct a programmable data processing apparatus to perform a series of steps, such that the instructions execute in a manner that implements the functionality described and shown herein. For example, the instructions may cause the system to execute a sequence of operations involving note creation, review, approval, issuance, and collaboration on structured notes in a network-based environment.

The figures are intended to illustrate the architecture, functionality, and operation of the described embodiments. It will be appreciated that the blocks shown in the diagrams may be rearranged, and that functions assigned to individual blocks may occur in a different order or arrangement than that presented. It is understood that each block may be implemented through hardware-based systems, software-based systems, or a combination of both, without departing from the scope of the invention.

In some embodiments, the system and method described herein leverages a distributed, network-enabled architecture to facilitate the creation, issuance, and management of structured notes, while providing mechanisms for collaboration between multiple Users. The system may utilize a combination of dynamic resource allocation, secure data transmission, and optimized data synchronization to ensure that the structured note lifecycle—from creation to issuance and beyond—is handled with high efficiency, accuracy, and security. The invention provides a scalable and robust platform for the management of complex financial instruments, enabling secure collaboration among Users through a combination of configurations and integrations.

In some embodiments, the system is built on a distributed architecture comprising multiple User devices, secure data servers associated with the user interface 100, and, optionally, intermediary nodes that facilitate the real-time transmission and processing of financial data. In some embodiments, the system implements a load-balancing mechanism that dynamically allocates computing resources based on transaction volume, thereby mitigating performance bottlenecks during periods of peak demand. Additionally, in some embodiments, the system utilizes a multi-layered encryption protocol that secures transaction data at various stages of transmission, protecting sensitive financial information from interception and unauthorized access.

In some embodiments, the system implements intelligent data synchronization techniques that ensure consistency of User account information and transaction histories across all client devices and servers. This is particularly important in scenarios where users access the platform from multiple User devices or where intermittent network connectivity could otherwise lead to discrepancies in financial records. In some embodiments, the synchronization protocol operates in the background, monitoring network conditions and utilizing optimized data compression techniques to minimize bandwidth consumption without sacrificing data accuracy.

In some embodiments, the system and method incorporate machine learning algorithms to detect patterns of anomalous behavior in transaction data, allowing for proactive identification and mitigation of fraudulent activities in a manner that enhances the security and reliability of the system.

By introducing these technical improvements, the system and method described herein provides a specific solution to challenges related to the performance, security, and scalability of financial transaction processing in distributed computing environments. These advancements represent a tangible improvement in the field of financial computing technology, ensuring faster transaction processing, enhanced data security, and greater system reliability.

1. In some embodiments, the method for creating, issuing, and managing structured notes includes: enabling communication and collaboration among Note Creators, Note Issuers, and Customers through a user interface; transmitting a proposed structured note from the Note Creator to the Note Issuer, which includes terms and conditions; accepting or rejecting the terms and conditions by the Note Issuer; broadcasting the availability of the structured note for purchase to the Customer if accepted; processing orders associated with the purchase or sale of the structured note, a position associated with the structured note; broadcasting notifications about the status of the structured note based on events within the user interface or market data from third-party sources. In some embodiments, the Note Creator creates the proposed note based at least upon data associated with an underlying asset or index, a principal protection component, a return component, and a maturity date, wherein at a least a portion of the data is obtained from the third party data source integrated with the user interface.

In some embodiments the method carries out the proposal, acceptance, and broadcasting steps on the same day. The user interface can be integrated with at least one external system associated with either the Note Creator, Note Issuer, or Customer, the at least one external system including an investment account configured to process electronic funds transfers. Notifications associated with the status of the structured note based on events occurring within the user interface are selected from a list consisting of: Draft Created, Note Launched, Note Closes in 1 hour, Note Closed, Term Sheet Available, Note Observed, Payment Pending, Payment Missed, Payment Paid, RIA Added, Investment Advisor Added, End User Investor Added, RIA Profile Changed, and End User Investor Weekly Summary Available, or combinations thereof. Notifications associated with the status of the structured note based on market data obtained from a third-party data source are selected from a list consisting of: Note Breached, Note Sold, Call Alert, Note Called, Six Months To Maturity, Three Months To Maturity, One Month To Maturity, and One Week To Maturity, or combinations thereof;

In some embodiments, the system includes a user interface integrated with data sources and external systems, and it is configured to handle various notifications and transactions related to the structured notes as described in the method steps recited herein.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in many ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing detailed description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A method of creating, issuing, and managing structured notes, comprising:
a. providing a user configured to enable communication and collaboration among at least one Note Creator, at least one Note Issuer, and at least one Customer;
b. transmitting a proposed structured note to the Note Issuer, the proposed structured note created by the Note Creator through the user interface, the proposed structured note including one or more terms and conditions;
C. transmitting from the Note Issuer to the Note Creator acceptance or rejection of the terms and conditions of the proposed structured note;
d. if the proposed structured note is accepted by the Note Issue, broadcasting to the Customer via the user interface the availability of the structured note for purchase;
e. processing via the user interface at least one order associated with the purchase of the structured note; and
f. broadcasting via the user interface at least one notification associated with the status of the structured note, wherein the at least one notification is based one events occurring within the user interface or on market data obtained from a third party data source integrated with the user interface.

2. The method of claim 1, wherein the Note Creator creates the proposed note based at least upon data associated with an underlying asset or index, a principal protection component, a return component, and a maturity date, wherein at a least a portion of the data is obtained from the third party data source integrated with the user interface.

3. The method of claim 1, wherein steps (b) through (d) occur during the same day.

4. The method of claim 1, wherein the user interface is integrated with at least one external system associated with either the Note Creator, Note Issuer, or Customer.

5. The method of claim 4, wherein the at least one external system includes an investment account configured to process electronic funds transfers.

6. The method of claim 1, wherein the at least one notification associated with the status of the structured note based on events occurring within the user interface is selected from the list consisting of Draft Created, Note Launched, Note Closes in 1 hour, Note Closed, Term Sheet Available, Note Observed, Payment Pending, Payment Missed, Payment Paid, RIA Added, Investment Advisor Added, End User Investor Added, RIA Profile Changed, and End User Investor Weekly Summary Available, or combinations thereof.

7. The method of claim 1, wherein the at least one notification associated with the status of the structured note based on market data obtained from a third party data source is selected from the list consisting of Note Breached, Note Sold, Call Alert, Note Called, Six Months To Maturity, Three Months To Maturity, One Month To Maturity, and One Week To Maturity, or combinations thereof.

8. The method of claim 1, further including the step of processing, via the user interface, at least one sell transaction between the Customer and the Note Issuer associated with the structured note.

9. A system for creating, issuing, and managing structured notes, comprising:
a user interface configured to enable communication and collaboration among at least one Note Creator, at least one Note Issuer, and at least one Customer;
the user interface integrated with at least one data source associated with either the Note Creator, Note Issuer, or Customer or, optionally, a third party data source;
wherein the system is configured to:
transmit a proposed structured note to the Note Issuer, the proposed structured note created by the Note Creator through the user interface, the proposed structured note including one or more terms and conditions;
transmit from the Note Issuer to the Note Creator acceptance or rejection of the terms and conditions of the proposed structured note;
if the proposed structured note is accepted by the Note Issue, broadcast to the Customer via the user interface the availability of the structured note for purchase;
process via the user interface at least one order associated with the purchase of the structured note; and
broadcast via the user interface at least one notification associated with the status of the structured note, wherein the at least one notification is based one events occurring within the user interface or on market data obtained from a third party data source integrated with the user interface.

10. The system of claim 9, wherein the proposed structured note is created by the Note Creator based at least upon data associated with an underlying asset or index, a principal protection component, a return component, and a maturity date, wherein at a least a portion of the data is obtained from the third party data source integrated with the user interface.

11. The system of claim 9, wherein the user interface is integrated with at least one external system associated with either the Note Creator, Note Issuer, or Customer.

12. The system of claim 11, wherein the at least one external system includes an investment account configured to process electronic funds transfers.

13. The system of claim 9, wherein the at least one notification associated with the status of the structured note based on events occurring within the user interface is selected from the list consisting of Draft Created, Note Launched, Note Closes in 1 hour, Note Closed, Term Sheet Available, Note Observed, Payment Pending, Payment Missed, Payment Paid, RIA Added, Investment Advisor Added, End User Investor Added, RIA Profile Changed, and End User Investor Weekly Summary Available, or combinations thereof.

14. The system of claim 9, wherein the at least one notification associated with the status of the structured note based on market data obtained from a third party data source is selected from the list consisting of Note Breached, Note Sold, Call Alert, Note Called, Six Months To Maturity, Three Months To Maturity, One Month To Maturity, and One Week To Maturity, or combinations thereof.

15. The system of claim 9, further including the step of processing, via the user interface, at least one sell transaction between the Customer and the Note Issuer associated with the structured note.

16. The system of claim 9, wherein the user interface is configured to display a configurable dashboard to at least one of the Note Creator, the Note Issuer, and the Customer.

17. The system of claim 9, wherein the user interface is configured to assign an encrypted storage sub-system to at least one of the Note Creator, the Note Issuer, and the Customer.
